(19) United States
(12) Patent Application Publication
(10) Pub. No.: US 2013/0339964 A1
(43) Pub. Date: Dec. 19, 2013

(54) REPLAYING OF WORK ACROSS CLUSTER OF DATABASE SERVERS

(71) Applicants: Curt L. COTNER, Gilroy, CA (US); Sherry X. GUO, Fremont, CA (US); Thomas J. TOOMIRE, Morgan Hill, CA (US); John E. VONAU, Brighton, CO (US); Fang-Yi WANG, San Jose, CA (US); Catalina Y. WEI, San Jose, CA (US)

(72) Inventors: Curt L. COTNER, Gilroy, CA (US); Sherry X. GUO, Fremont, CA (US); Thomas J. TOOMIRE, Morgan Hill, CA (US); John E. VONAU, Brighton, CO (US); Fang-Yi WANG, San Jose, CA (US); Catalina Y. WEI, San Jose, CA (US)

(73) Assignee: INTERNATIONAL BUSINESS MACHINES CORPORATION, Armonk, NY (US)

(21) Appl. No.: 13/525,246

(22) Filed: Jun. 15, 2012

(51) Int. Cl. G06F 9/46

(52) U.S. Cl. 718/102

(57) ABSTRACT

The replaying of work across a database servers includes: receiving a global time by each of a plurality of replay dispatchers; calculating, for each given replay dispatcher, a time offset using a local time for the given replay dispatcher and the global time; receiving, for each given replay dispatcher, a replay workload comprising a plurality of replay records and a global replay start time, wherein each of the plurality of replay records comprises an expected wait time; calculating, for each given replay dispatcher, a wait time for each given replay record based on the expected wait time for the given replay record, the global replay start time, and the time offset for the given replay dispatcher; and submitting, for each given replay dispatcher, the replay records to a target database server for processing in an order according to the calculated wait times.

### BACKGROUND

Many customers have complex information technology environments that are critical to running their businesses. The environments include large production databases and sophisticated workloads. Changes to production systems must be thoroughly tested to ensure safety. In general, proposed changes to the production systems are first tested on test systems before being applied to the production systems. To obtain as accurate test results as possible, these tests should be conducted by running the workload of Structured Query Language (SQL) statements and transactions in the same order as were seen on the production system. However, running a workload that closely approximates an original transaction and SQL statement order is very difficult, especially when the workload can be replayed across a cluster of database servers. Existing approaches replay the same set of SQL statements but lack the ability to preserve an original workload's execution order.

### SUMMARY

According to one embodiment of the present invention, a method for replaying work implemented by a processor of a computing device, comprises: receiving a global time by each of a plurality of replay dispatchers; calculating, by the processor for each given replay dispatcher, a time offset using a local time for the given replay dispatcher and the global time; receiving, by the processor for each given replay dispatcher, a replay workload comprising a plurality of replay records and a global replay start time, wherein each of the plurality of replay records comprises an expected wait time; calculating, by the processor for each given replay dispatcher, a wait time for each given replay record based on the expected wait time for the given replay record, the global replay start time, and the time offset for the given replay dispatcher; and submitting, by the processor for each given replay dispatcher, the replay records to a target database server for processing in an order according to the calculated wait times.

In one aspect of the present invention, the receiving the global time by each of the plurality of replay dispatchers comprises: broadcasting by a global time keeper the global time to each of the plurality of replay dispatchers.

In one aspect of the present invention, the calculating the time offset using the local time for the given replay dispatcher and the global time, comprises: calculating a difference between the local time for the given replay dispatcher (DLT) and the global time; and saving the difference as a dispatcher time adjustment (DTA) for the given replay dispatcher.

In one aspect of the present invention, the calculating the wait time for each given replay record based on the expected wait time (EW) for the given replay record, the global replay start time (GRT), and the time offset for the given replay dispatcher, comprises: calculating, by the processor for each given replay dispatcher, the wait time (WT) for each given replay record as equal to EW−(DLT+DTA−GRT).

In one aspect of the present invention, the calculating the wait time for each given replay record based on the expected wait time for the given replay record, the global replay start time, and the time offset for the given replay dispatcher, further comprises: determining that a throttling factor is to be applied to the expected wait time; adjusting the expected wait time based on the throttling factor; and updating the wait time using the adjusted expected wait time.

In one aspect of the present invention, the submitting, by the processor for each given replay dispatcher, the replay records to the target database server for processing in the order according to the calculated wait times, comprises: submitting, by the processor for each given replay dispatcher, the replay records to the target database server for processing in the order according to the updated wait times.

In one aspect of the present invention, each given replay dispatcher is configured with a priority and a capacity, where the receiving, by the processor for each given replay dispatcher, the replay workload comprising the plurality of replay records and the global replay start time, comprises: determining, by the processor for a replay router, that the given replay dispatcher is associated with the replay records for a database connection; determining, by the processor for the replay router, whether the given replay dispatcher comprises the capacity for the replay records; and in response to determining that the given replay dispatcher comprises the capacity for the replay records, routing the replay records to the given replay dispatcher and decrementing the priority and the capacity for the given replay dispatcher.

System and computer program products corresponding to the above-summarized methods are also described and claimed herein.

### BRIEF DESCRIPTION OF THE SEVERAL VIEWS OF THE DRAWINGS

FIG. 1 illustrates an embodiment of a system for replaying work according to the present invention.

FIG. 2 illustrates an embodiment of the system according to the present invention comprising three components implemented by one or more computing devices.

FIG. 3 is a flowchart illustrating an embodiment of a method for replaying work across a cluster of database servers according to the present invention.

FIG. 4 is a flowchart illustrating in more detail the embodiment of a method for replaying work according to the present invention.

FIG. 5 is a flowchart illustrating an embodiment of selecting a dispatcher in routing replay records according to the present invention.

FIG. 6 illustrates an embodiment of the system according to the present invention where the dispatchers are implemented in different computing devices across distributed processes.

FIG. 7 illustrates an embodiment of the system according to the present invention where a dispatcher is implemented on the same computing device as the database server.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java® (Java, and all Java-based trademarks and logos are trademarks of Sun Microsystems, Inc. in the United States, other countries, or both), Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer special purpose computer or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified local function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

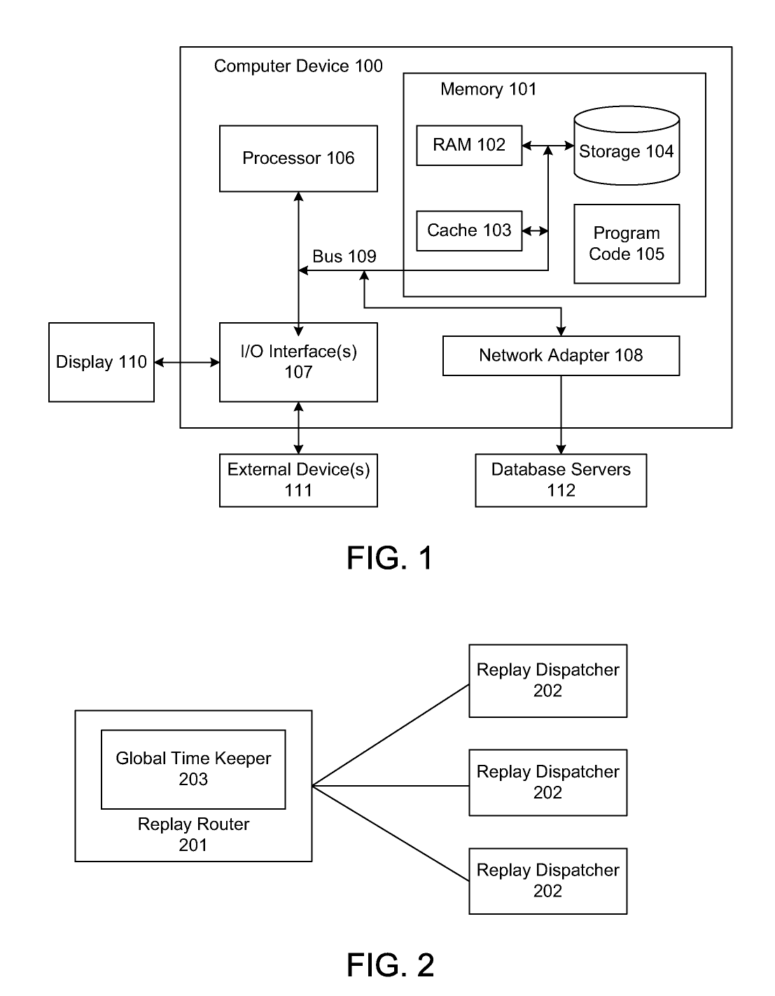

FIG. 1 illustrates an embodiment of a system for replaying work according to the present invention. The system comprises a computing device 100 operationally coupled to a processor or processing units 106, a memory 101, and a bus 109 that couples various system components, including the memory 101 to the processor 106. The bus 109 represents one or more of any of several types of bus structure, including a memory bus or memory controller, a peripheral bus, an accelerated graphics port, and a processor or local bus using any of a variety of bus architectures. The memory 101 may include computer readable media in the form of volatile memory, such as random access memory (RAM) 102 or cache memory 103, or non-volatile storage media 104. The memory 101 may include at least one program product having a set of at least one program code module 105 that are configured to carry out the functions of embodiments of the present invention when executed by the processor 106. The computing device 100 may also communicate with one or more external devices 111, such as a display 24, via I/O interfaces 107. The computing device 100 may communicate with one or more database servers 112 via network adapter 108.

Embodiments of the present invention replays a production level workload across a cluster of database servers 112 that closely approximates an original transaction and SQL statement order with minimal CPU and network overhead. As illustrated in FIG. 2, an embodiment of the system according to the present invention comprising three components implemented by one or more computing devices 100: a replay router 201; a plurality of replay dispatchers 202; and the global time keeper 103. The replay router 201 serves as the central agent who distributes work among the dispatchers 202. The replay router 201 performs load balancing among the dispatchers 202, such that no one particular dispatcher becomes overwhelmed with work. The replay router 201 also has the ability to detect distressed dispatchers and dynamically start up new dispatchers as needed. Each replay dispatcher 202 receives work from the replay router 201 and submits the work to a database server 112. Replay status information is collected by the dispatchers 202 and reported back to the replay router 201. The global time keeper 203 coordinates the time between the replay router 201 and the dispatchers 202. The ability to operate on the same “global time” allows the maintenance of the execution sequence when working with distributed dispatchers 202.

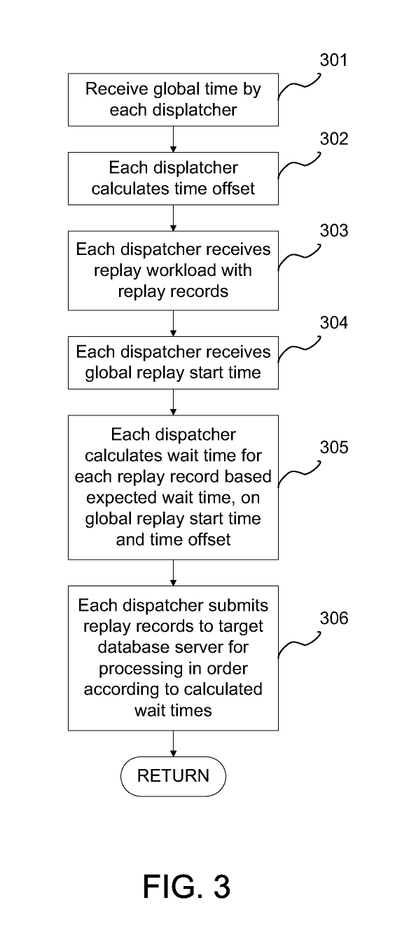

FIG. 3 is a flowchart illustrating an embodiment of a method for replaying work according to the present invention. In this embodiment, in response to receiving a global time from the global time keeper 203 (301), each dispatcher 202 calculates a time offset as a difference between the dispatcher's own local time and the global time received from the global time keeper 203 (302). As the local times at the dispatchers 202 may vary, the time offsets among the dispatchers 202 may vary. At some time after receiving the global time and calculating the time offset, each dispatcher receives from the replay router 201 a replay workload comprising a plurality of replay records (303).

A replay record, as used in this specification, comprises a single workload operation that can be replayed against a target database. For example, the replay record includes information about a specific SQL operation to execute, such that the order of execution of SQL operations in the plurality of replay records can closely approximate the order in the original production workload. Each replay record may include the SQL action to be replayed and any additional details required to replay the action, such as the SQL statement text and host variable values. Example SQL actions include connect, open, fetch, close, commit, and rollback. Each replay record may also include information about the results of the SQL action in the original production workload, such as how many rows a SQL select statement returned and what was the SQLCODE of the action in the original workload. Each replay record further includes a connection and transaction identifier that allows the SQL operation to execute on the appropriate connection in order to closely approximate the original production workload.

In this embodiment, each replay record further includes an expected wait time, which is the execution time of this replay record relative to the first record in the workload. Each dispatcher 202 also receives a global replay start time for the replay workloads from the replay router 201 (304). In response to receiving the replay workload and the global replay start time, each dispatcher 202 calculates a wait time for each replay record in its respective workload based on the expected wait time for the replay record, the global replay start time, and the dispatcher's own time offset (305), as previously calculated (see 302). By each dispatcher 202 calculating the wait time for each replay record of its respective workload in this manner, the order of execution of the replay records across multiple dispatchers 202 are coordinated or ordered with reference to the global time. Each dispatcher 202 may then submit the replay records in its respective workload to the target database server 112 for processing in the order according to the calculated wait times (306).

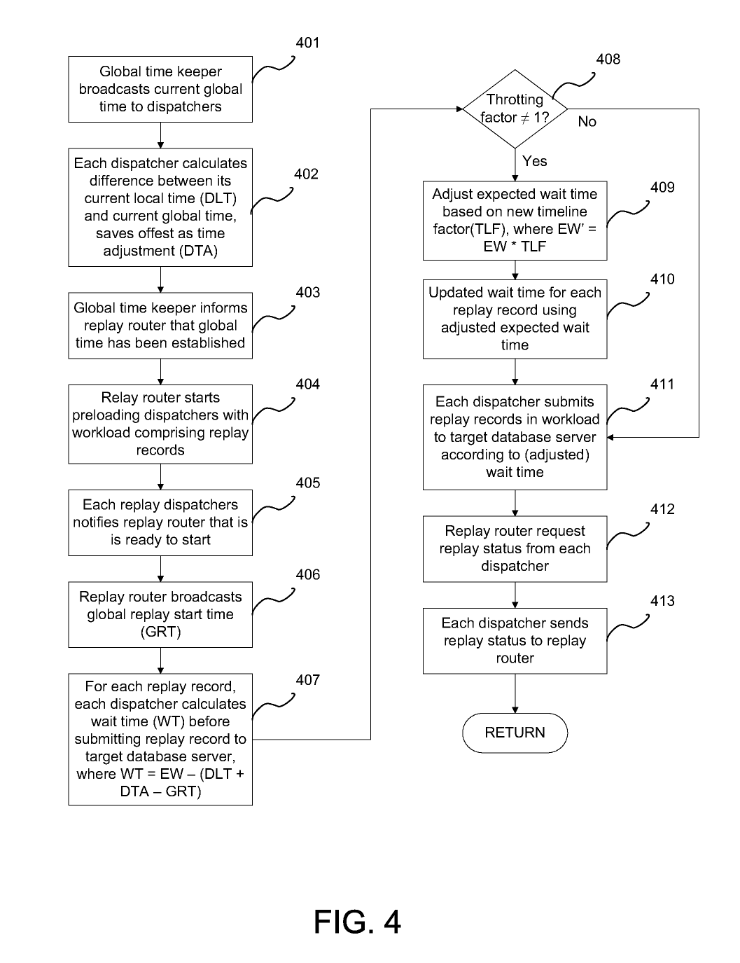

FIG. 4 is a flowchart illustrating in more detail the embodiment of a method for replaying work according to the present invention. The global time keeper 203 broadcasts its current local time to the dispatchers 202 as the current global time, taking into account possible network latency (401). In response to receiving the global time from the global time keeper 203, each dispatcher 202 calculates the difference between its own current local time (DLT) and the current global time received from the global time keeper 203 and saves the offset as the time adjustment (DTA) (402). The global time keeper 203 then informs the replay router 201 that the global time has been established (403). In response, the replay router 201 starts preloading the dispatchers 202 with workloads comprising replay records (404). The amount of work preloaded to a dispatcher may be configurable, with the work measured in the number and/or size of replay records. When each dispatcher 202 notifies the replay router 201 that it is ready to start execution of the workload (405), the replay router 201 broadcasts a global replay start time (GRT) (406). The GRT must be a future time for all dispatchers. Based on the expected wait time (EW) indicated by each replay record and the global replay start time, each dispatcher 202, for each replay record, calculates a wait time (WT) before submitting the replay record to the target database server, where WT=EW−(DLT+DTA=GRT) (407).

Optionally, the expected wait time (EW) may be adjusted according to a throttling factor. The throttling factor adjusts the expected wait time based on a timelines factor (TLF). In one embodiment, the timeline factor (TLF) is calculated as follows:

Timeline Factor

0.25 (replays the workload in one quarter of the time)

0.50 (replays the workload in half of the time)

1.00 (replays the workload at normal rate)

2.00 (replays the workload in double time)

When the throttling factor is not equal to 1 (408), the expected wait time (EW) is adjusted based on the timeline factor (TLF), where the new expected wait time (EW′) is calculated as follows: EW′=EW*TLF (409). The wait time (WT) for each replay record is then updated using the adjusted expected wait time (410), where the updated wait time (WT′)=EW′−(DLT+DTA−GRT). Each dispatcher 202 then submits the replay records in its respective workload to the target database server 112 according to the wait time (EW) or the adjusted wait time (EW′) (410). When the replay router 201 requests a replay status from each of the dispatchers 202 (411), each dispatcher 202 responds by sending the replay status to the replay router 201 (412).

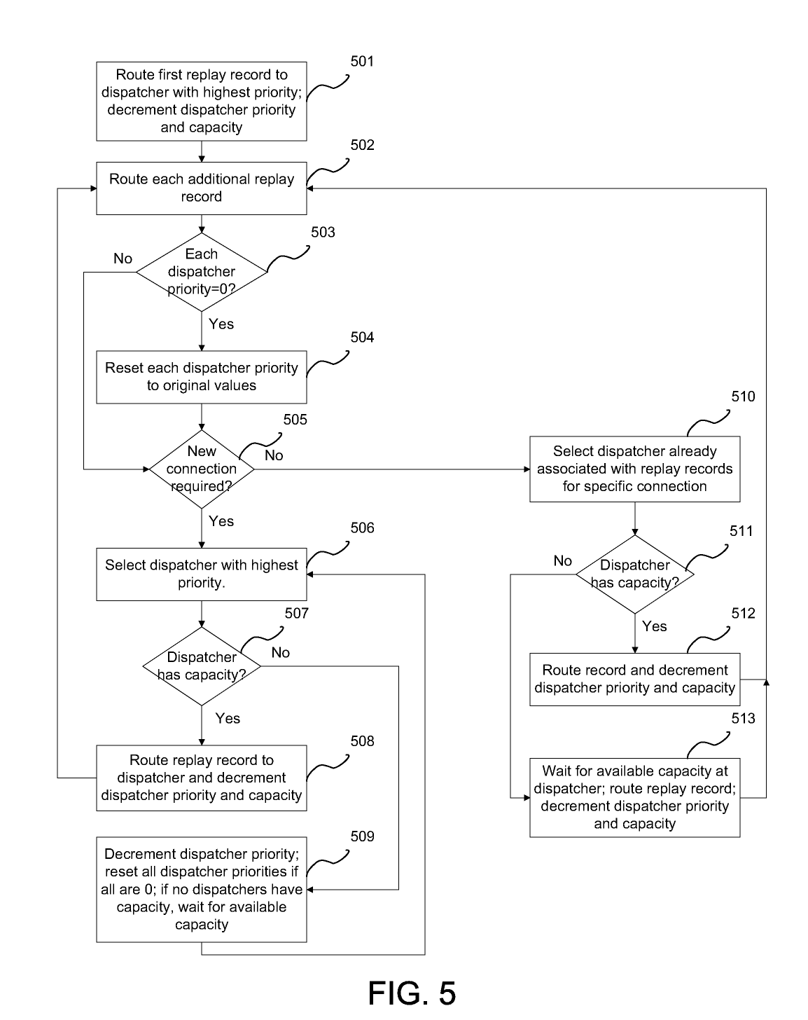

FIG. 5 is a flowchart illustrating an embodiment of selecting a dispatcher in routing replay records according to the present invention. In this embodiment, each dispatcher 202 is configured with a priority and a capacity. For a workload, the replay router 201 routes the first replay record to the dispatcher with the highest priority and decrements the dispatcher's priority and capacity (501). The replay router 201 then routes each additional replay record in the same manner (502). When each dispatcher 202 has a priority of zero (503), the replay router 201 resets the priority for each dispatcher 202 to its original value (504). The replay router 201 then determines whether a new connection is required (505). During the capture of SQL operations during the original production workload, operations that target the production database are recorded. One of these operations includes the creation of a SQL connection. This information on the SQL connection, along with the other information recorded during the capture phase, is used to create the replay records. In this embodiment, the capture record for a new connection is changed into a replay record for a new connection. When the replay router 201 reads the replay record for the new connection, the replay router 201 is able to determine that a new database connection is required (505), and the replay router 201 selects the dispatcher 202 with the highest priority (506). If the replay router 201 determines that the selected dispatcher 202 has the capacity for the replay record (507), the replay router 201 routes the replay record to the selected dispatcher 202 and decrements the dispatcher's priority and capacity (508). Otherwise, the replay route 201 decrements the selected dispatcher's priority (509). The replay router 201 further resets the priority of each dispatcher 202 if the priorities are all zero. If none of the dispatchers 202 has the capacity for the replay record, then the replay router 201 waits for available capacity on any of the dispatchers 202.

When a new database connection is not required (505), the replay router 201 selects the dispatcher already associated with the replay records for the specific connection (510). In this embodiment, all replay records for a particular database connection are to be routed to the same dispatcher. If the selected dispatcher 202 has the capacity for the replay record (511), then the replay router 201 routes the replay record to the selected dispatcher 202 and decrements the dispatcher's priority and capacity (512). The replay router 201 then returns to 502. Otherwise, the replay router 201 waits for available capacity at the selected dispatcher 202. Once the selected dispatcher 202 has the capacity, the replay router 201 routes the replay record to the selected dispatcher 202 and decrements the dispatcher's priority and capacity (513). The replay router 201 then returns to 502.

Embodiments of the present invention replays a production level workload across a cluster of database servers 112 that closely approximates an original transaction and SQL statement order without a need for messages to be passed between the replay router 201, the dispatchers 202, and the global time keeper 203, and thus incurs little CPU and network overhead.

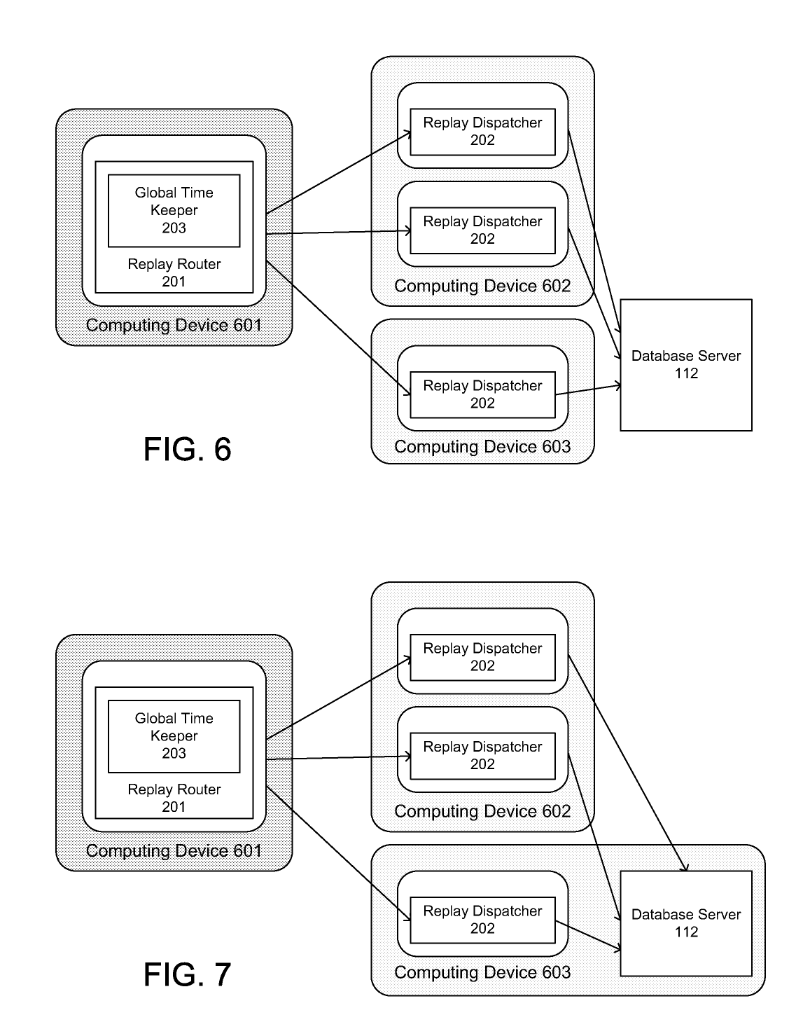

Embodiments of the present invention further have the flexibility of implementing the replay router 201 and the dispatcher(s) 202 in the same computing device or in different computing devices. FIG. 6 illustrates an embodiment of the system according to the present invention where the dispatchers are implemented in different computing devices across distributed processes. In this embodiment, the replay router 201 and the global time keeper 203 are implemented on one computing device 601, while the replay dispatchers 202 are implemented across two computing devices 602 and 603. FIG. 7 illustrates an embodiment of the system according to the present invention where a dispatcher is implemented on the same computing device as the database server 112. By implementing a dispatcher 202 on the same computing device 603 where the database server 112 resides, the dispatcher 202 is able to take advantage of resources readily available on the database server 112, including the local application programming interfaces (API's available at the database server 112). For example, when the original transaction used the local API at the database server 122, using the local API during the replay will more closely approximate the original transaction. This further allows the replay to mimic the network protocol used in the original transaction.

Embodiments of the present invention further do not require modification of the database engine code at the database server 112, and do not require assistance from the database engine code to coordinate the replay. The embodiments of the present invention thus do not negatively impact database performance.

Embodiments of the present invention support the replay of both dynamic SQL and static SQL statement. As is known in the art, dynamic and static SQL statements are executed differently. Information on the execution of the dynamic and the static SQL statements are recorded in the replay records during the capture phase. This information may include the static package and section that is used to execute the statement. Based on this information in the replay records, the dispatchers 202 make determinations on which API's to use when executing the statement during the replay. Thus, dynamic SQL in the original transaction may be replayed as dynamic SQL, while static SQL in the original transaction may be replayed as static SQL. This further allows the replay to more closely approximate the original transaction.

The descriptions of the various embodiments of the present invention has been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for replaying work implemented by a processor of a computing device, comprising:
receiving a global time by each of a plurality of replay dispatchers;
calculating, by the processor for each given replay dispatcher, a time offset using a local time for the given replay dispatcher and the global time;
receiving, by the processor for each given replay dispatcher, a replay workload comprising a plurality of replay records and a global replay start time, wherein each of the plurality of replay records comprises an expected wait time;
calculating, by the processor for each given replay dispatcher, a wait time for each given replay record based on the expected wait time for the given replay record, the global replay start time, and the time offset for the given replay dispatcher; and
submitting, by the processor for each given replay dispatcher, the replay records to a target database server for processing in an order according to the calculated wait times.

2. The method of claim 1, wherein the receiving the global time by each of the plurality of replay dispatchers comprises:
broadcasting by a global time keeper the global time to each of the plurality of replay dispatchers.

3. The method of claim 1, wherein the calculating the time offset using the local time for the given replay dispatcher and the global time, comprises:
calculating a difference between the local time for the given replay dispatcher (DLT) and the global time; and
saving the difference as a dispatcher time adjustment (DTA) for the given replay dispatcher.

4. The method of claim 3, wherein the calculating the wait time for each given replay record based on the expected wait time (EW) for the given replay record, the global replay start time (GRT), and the time offset for the given replay dispatcher, comprises:
calculating, by the processor for each given replay dispatcher, the wait time (WT) for each given replay record as equal to EW−(DLT+DTA−GRT).

5. The method of claim 4, wherein the calculating the wait time for each given replay record based on the expected wait time for the given replay record, the global replay start time, and the time offset for the given replay dispatcher, further comprises:
determining that a throttling factor is to be applied to the expected wait time;
adjusting the expected wait time based on the throttling factor; and
updating the wait time for each given replay record using the adjusted expected wait time.

6. The method of claim 5, wherein the submitting, by the processor for each given replay dispatcher, the replay records to the target database server for processing in the order according to the calculated wait times, comprises:
submitting, by the processor for each given replay dispatcher, the replay records to the target database server for processing in the order according to the updated wait times.

7. The method of claim 1, wherein each given replay dispatcher is configured with a priority and a capacity, wherein the receiving, by the processor for each given replay dispatcher, the replay workload comprising the plurality of replay records and the global replay start time, comprises:
determining, by the processor for a replay router, that the given replay dispatcher is associated with the replay records for a database connection;
determining, by the processor for the replay router, whether the given replay dispatcher comprises the capacity for the replay records; and
in response to determining that the given replay dispatcher comprises the capacity for the replay records, routing the replay records to the given replay dispatcher and decrementing the priority and the capacity for the given replay dispatcher.

8. A computer program product for replaying work, the computer program product comprising:
a computer readable memory having computer readable program code embodied therewith, the computer readable program code configured to:
receive a global time by each of a plurality of replay dispatchers;
calculate, for each given replay dispatcher, a time offset using a local time for the given replay dispatcher and the global time;
receive, for each given replay dispatcher, a replay workload comprising a plurality of replay records and a global replay start time, wherein each of the plurality of replay records comprises an expected wait time;
calculate, for each given replay dispatcher, a wait time for each given replay record based on the expected wait time for the given replay record, the global replay start time, and the time offset for the given replay dispatcher; and
submit, for each given replay dispatcher, the replay records to a target database server for processing in an order according to the calculated wait times.

9. The computer program product of claim 8, wherein the computer readable program code configured to receive the global time by each of the plurality of replay dispatchers is further configured to:
broadcast by a global time keeper the global time to each of the plurality of replay dispatchers.

10. The computer program product of claim 8, wherein the computer readable program code configured to calculate the time offset using the local time for the given replay dispatcher and the global time, is further configured to:
calculate a difference between the local time for the given replay dispatcher (DLT) and the global time; and
save the difference as a dispatcher time adjustment (DTA) for the given replay dispatcher.

11. The computer program product of claim 10, wherein the computer readable program code configured to calculate the wait time for each given replay record based on the expected wait time (EW) for the given replay record, the global replay start time (GRT), and the time offset for the given replay dispatcher, is further configured to:
calculate, for each given replay dispatcher, the wait time (WT) for each given replay record as equal to EW−(DLT+DTA−GRT).

12. The computer program product of claim 11, wherein the computer readable program code configured to calculate the wait time for each given replay record based on the expected wait time for the given replay record, the global replay start time, and the time offset for the given replay dispatcher, is further configured to:
determine that a throttling factor is to be applied to the expected wait time;
adjust the expected wait time based on the throttling factor; and
update the wait time for each given replay record using the adjusted expected wait time.

13. The computer program product of claim 12, wherein the computer readable program code configured to submit, for each given replay dispatcher, the replay records to the target database server for processing in the order according to the calculated wait times, is further configured to:
submit, for each given replay dispatcher, the replay records to the target database server for processing in the order according to the updated wait times.

14. The computer program product of claim 8, wherein each given replay dispatcher is configured with a priority and a capacity, wherein the computer readable program code configured to receive, for each given replay dispatcher, the replay workload comprising the plurality of replay records and the global replay start time, is further configured to:
determine, for a replay router, that the given replay dispatcher is associated with the replay records for a database connection;
determine, for the replay router, whether the given replay dispatcher comprises the capacity for the replay records; and
in response to determining that the given replay dispatcher comprises the capacity for the replay records, route the replay records to the given replay dispatcher and decrement the priority and the capacity for the given replay dispatcher.

15. A system comprising:
a processor; and
a computer readable memory having computer readable program code embodied therewith, the computer readable program code configured to:
receive a global time by each of a plurality of replay dispatchers;
calculate, for each given replay dispatcher, a time offset using a local time for the given replay dispatcher and the global time;
receive, for each given replay dispatcher, a replay workload comprising a plurality of replay records and a global replay start time, wherein each of the plurality of replay records comprises an expected wait time;
calculate, for each given replay dispatcher, a wait time for each given replay record based on the expected wait time for the given replay record, the global replay start time, and the time offset for the given replay dispatcher; and
submit, for each given replay dispatcher, the replay records to a target database server for processing in an order according to the calculated wait times.

16. The system of claim 15, wherein the computer readable program code configured to receive the global time by each of the plurality of replay dispatchers is further configured to:
broadcast by a global time keeper the global time to each of the plurality of replay dispatchers.

17. The system of claim 15, wherein the computer readable program code configured to calculate the time offset using the local time for the given replay dispatcher and the global time, is further configured to:
calculate a difference between the local time for the given replay dispatcher (DLT) and the global time; and
save the difference as a dispatcher time adjustment (DTA) for the given replay dispatcher.

18. The system of claim 17, wherein the computer readable program code configured to calculate the wait time for each given replay record based on the expected wait time (EW) for the given replay record, the global replay start time (GRT), and the time offset for the given replay dispatcher, is further configured to:
calculate, for each given replay dispatcher, the wait time (WT) for each given replay record as equal to EW−(DLT+DTA−GRT).

19. The system of claim 18, wherein the computer readable program code configured to calculate the wait time for each given replay record based on the expected wait time for the given replay record, the global replay start time, and the time offset for the given replay dispatcher, is further configured to:
determine that a throttling factor is to be applied to the expected wait time;
adjust the expected wait time based on the throttling factor; and
update the wait time for each given replay record using the adjusted expected wait time.

20. The system of claim 19, wherein the computer readable program code configured to submit, for each given replay dispatcher, the replay records to the target database server for processing in the order according to the calculated wait times, is further configured to:
submit, for each given replay dispatcher, the replay records to the target database server for processing in the order according to the updated wait times.
